(19) United States
(12) Patent Application Publication
(10) Pub. No.: US 2020/0412137 A1
(43) Pub. Date: Dec. 31, 2020

(54) Power Sharing Methods and Systems for Use With a Capture Device

(71) Applicant: ZEBRA TECHNOLOGIES CORPORATION, Lincolnshire, IL (US)

(72) Inventor: Christopher P. Klicpera, Westbury, NY (US)

(21) Appl. No.: 16/452,156

(22) Filed: Jun. 25, 2019

(51) Int. Cl. H02J 7/00; G06K 7/10; H02J 50/12

(52) U.S. Cl. CPC H02J 7/0029; G06K 7/10158; H02J 7/0052; H02J 2007/0039; H02J 50/12; H02J 2007/0062; H02J 7/0045

(57) ABSTRACT

Systems and methods for charging a rechargeable battery of a barcode reader are provided. In one example, two connectors of an interface device are connected to two corresponding host-provided power sources, each with limited output current capacity. The output currents of the host-provided power sources are combined to provide a combined current to a power storage unit of the interface device, which provides power to a wireless power transmitter of the interface device. The wireless power transmitter wirelessly transmits the power received from the power storage unit to a wireless power receiver of the barcode reader that provides power to a rechargeable battery of the barcode reader. In other examples, the interface device does not include a power storage unit, and the battery chargers are replaced with current limiters (e.g., current limited switches with reverse protection).

### BACKGROUND OF THE INVENTION

Wireless charging has many advantages over wired charging using traditional metal contacts. In particular, wireless charging greatly reduces the wear and tear and corrosion issues that users experience when using traditional metal contacts. Furthermore, wireless charging is particularly useful in healthcare settings because devices can be much more easily sterilized when there is no risk of cleaning agents entering charging ports. Accordingly, there is a need for a wireless charger for a barcode reader.

Standard Universal Serial Bus (USB) ports are limited to 500 mA max (equivalent to 2.5 W). This very limited power budget is barely enough to charge a high performance cordless barcode reader in an acceptable amount of time, even over traditional metal contacts. However, wireless power transfer technology is much less efficient compared to traditional metal contacts, which, when combined with the limited power budget of a standard USB port, increases charge times beyond what is acceptable. In some cases, using wireless power transfer technology powered by a standard USB port may not even charge the battery of a high performance cordless barcode reader.

As a result, products using wireless power transfer typically require a dedicated power supply to power their transmitters since 2.5 W from a standard USB port results in a charge time that is too long to be practical. However, using a dedicated power supply to power a wireless power transmitter can lead to other issues. Power supplies add significant cost, wire management, and open the door to electromagnetic interference via AC lines. Moreover, power supplies are typically shunned by healthcare customers where wireless power is of the most benefit due to inherent sealing against cleaning agents.

In particular, barcode scanners used in healthcare settings are typically installed on battery powered mobile carts that are moved from one area to another, so external power supplies that require an AC outlet are essentially a non-starter. To expand, the mobile cart is usually a display monitor attached to a laptop or portable PC powered from a battery in the base of the cart. In this context, barcode scanners and cradles are generally treated as peripheral devices (e.g., like a mouse or a keyboard) and are typically expected to operate from USB.

Accordingly, there exists a need for a USB-powered wireless power transmitter that is capable of charging a high performance cordless barcode reader in an acceptable amount of time while maintaining full USB compliance.

### SUMMARY

In examples herein, the present disclosure addresses the need for a USB-powered wireless power transmitter that is capable of charging a high performance cordless barcode reader in an acceptable amount of time while maintaining full USB compliance by using a microcontroller with two USB Peripheral PHYs to enumerate as two separate USB peripherals on two USB ports of a host device. A special combination of circuitry limits input current from each of the USB ports of the host device to at or below the standard 500 mA USB limit. Accordingly, the combined 1 A of current is sufficient to operate the wireless power transmitter to charge a cordless barcode reader. Consequently, if either of the USB ports is disconnected or suspended then operation of the wireless power transmitter is halted gracefully, and neither port can be overloaded. In this way, legitimate USB compliance is retained at all times. That is, there is no “illegal” power stealing or overloading of standard USB host ports. The solution can be scaled beyond two ports and can also take advantage of additional host features such as BC1.2, to the extent that they are available.

Generally speaking, a host computing device that has at least two power sources with limited output current capacity (e.g., USB ports with 500 mA max output current) may be connected to an interface device (e.g., a cradle) that interfaces with a wireless power receiver of a barcode reader that provides power to a rechargeable battery of the barcode reader. For instance, a first connector (e.g., a first USB cable) may connect the first host-provided power source to a first battery charger of the interface device, while a second connector (e.g., a second USB cable) may connect the second host-provided power source to a second battery charger of the interface device. The battery chargers may combine the power from the first and second host-provided power sources and provide the combined power to a power storage unit (e.g., a battery or a capacitor). The power storage unit may provide power to a wireless power transmitter, which may in turn wirelessly transmit the received power to a wireless power receiver of the barcode reader. The wireless power receiver of the barcode reader may provide power to a rechargeable battery of the barcode reader.

In an embodiment, the present invention is a system, comprising: a host computing device having: a first host-provided power source having a first limited output current capacity; and a second host-provided power source having a second limited output current capacity; and an interface device configured to interface with a wireless power receiver of a barcode reader that provides power to a rechargeable battery of the barcode reader, the interface device having: a first connector connected to the first host-provided power source; a second connector connected to the second host-provided power source; a power storage unit configured to receive combined current from the first host-provided power source and the second host-provided power source; and a wireless power transmitter configured to receive power from the power storage unit and transmit the power received from the power storage unit wirelessly to the wireless power receiver of the barcode reader.

In another embodiment, the present invention is an interface device for interfacing with a wireless power receiver of a barcode reader that provides power to a rechargeable battery of the barcode reader and for further interfacing with a host computing device having a first host-provided power source having a first limited output current capacity and a second host-provided power source having a second limited output current capacity, the interface device comprising: a first connector connected to the first host-provided power source; a second connector connected to the second host-provided power source; a power storage unit configured to receive combined current from the first host-provided power source and the second host-provided power source; and a wireless power transmitter configured to receive power from the power storage unit and transmit the power received from the power storage unit wirelessly to the wireless power receiver of the barcode reader.

In still another embodiment, the present invention is a method of charging a rechargeable battery of a barcode reader, the method comprising: connecting a first connector of an interface device to a first host-provided power source having a first limited output current capacity, the interface device being configured to interface with a wireless power receiver of a barcode reader that provides power to a rechargeable battery of the barcode reader; connecting a second connector of the interface device to a second host-provided power source having a second limited output current capacity; combining a first output current of the first host-provided power source with a second output current of the second host-provided power source to provide a combined current to a power storage unit; providing power from the power storage unit to a wireless power transmitter; and transmitting the power received from the power storage unit wirelessly to the wireless power receiver of the barcode reader.

In another embodiment, the present invention is a system, comprising: a host computing device having: a first host-provided power source having a first limited output current capacity; and a second host-provided power source having a second limited output current capacity; and an interface device configured to interface with a wireless power receiver of a barcode reader that provides power to a rechargeable battery of the barcode reader, the interface device having: a first connector connecting the first host-provided power source to a first current limiter having a first limited input current capacity; a second connector connecting the second host-provided power source to a second current limiter having a second limited input current capacity; and a wireless power transmitter configured to receive combined current from the first current limiter and the second current limiter and transmit combined power from the first current limiter and the second current limiter wirelessly to the wireless power receiver of the barcode reader.

In still another embodiment, the present invention is an interface device for interfacing with a wireless power receiver of a barcode reader that provides power to a rechargeable battery of the barcode reader and for further interfacing with a host computing device having a first host-provided power source having a first limited output current capacity and a second host-provided power source having a second limited output current capacity, the interface device comprising: a first connector connecting the first host-provided power source to a first current limiter having a first limited input current capacity; a second connector connecting the second host-provided power source to a second current limiter having a second limited input current capacity; and a wireless power transmitter configured to receive combined current from the first current limiter and the second current limiter and transmit combined power from the first current limiter and the second current limiter wirelessly to the wireless power receiver of the barcode reader.

In another embodiment, the present invention is a method of charging a rechargeable battery, comprising: connecting, by a first connector of an interface device configured to interface with a wireless power receiver of a barcode reader, a first host-provided power source having a first limited output current capacity to a first current limiter of the interface device, the first current limiter having a first limited input current capacity; connecting, by a second connector of the interface device, a second host-provided power source having a second limited output current capacity to a second current limiter of the interface device, the second current limiter having a second limited input current capacity; combining a first output current of the first current limiter with a second output current of the second current limiter to provide a combined current to a wireless power transmitter of the interface device; and transmitting the power received by the wireless power transmitter wirelessly to the wireless power receiver of the barcode reader, wherein the wireless power receiver of the barcode reader is configured to provide power to a rechargeable battery of the barcode reader.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of a dual USB-powered cradle for wirelessly charging a barcode reader, in accordance with an embodiment of the present application.

FIG. 2 illustrates a block diagram of a dual USB-powered cradle, without an internal power storage unit, for wirelessly charging a barcode reader, in accordance with an embodiment of the present application

FIG. 3 illustrates a chart comparing charge times for an example barcode reader using traditional contact charging by a cradle powered by a single USB port, wireless charging by a cradle powered by a single USB port, and wireless charging by a cradle powered by a combination of two USB ports in accordance with embodiments of the present application.

FIG. 4 illustrates an exemplary flow diagram of a method for using multiple power sources with limited output capacity to power an interface device for wirelessly charging a barcode reader, in accordance with an embodiment of the present application.

FIG. 5 illustrates an exemplary flow diagram of another method for using multiple power sources with limited output capacity to power an interface device for wirelessly charging a barcode reader, in accordance with an embodiment of the present application.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

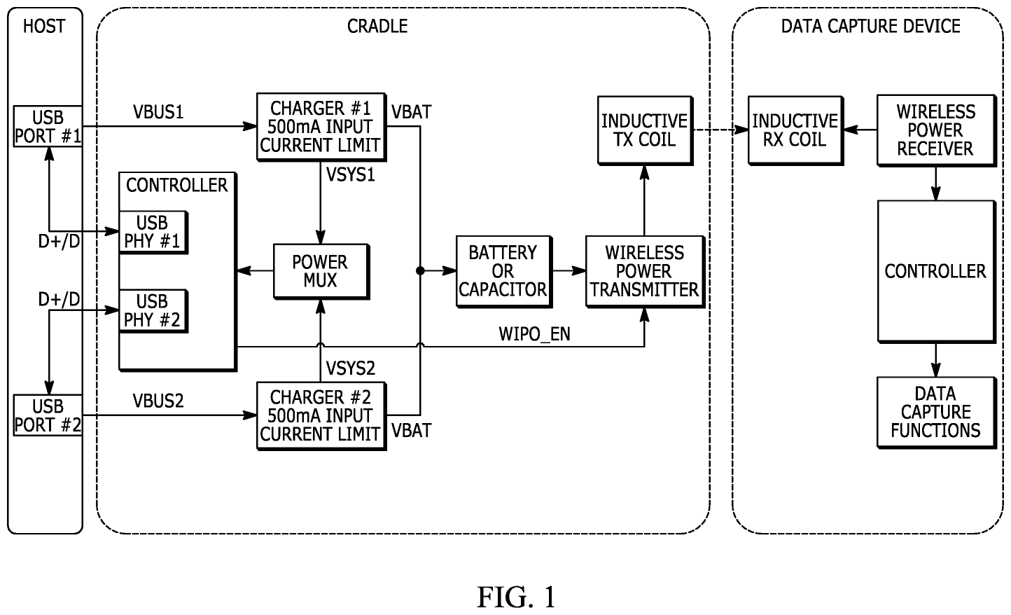

In FIG. 1, a block diagram of an exemplary dual USB-powered cradle for wirelessly charging a barcode reader is illustrated, in accordance with an embodiment of the present application. As shown in FIG. 1, a host computing device is connected to the cradle, which in turn wirelessly transmits power to a data capture device (e.g., a barcode reader). The host computing device may have two or more USB ports. The cradle includes two battery chargers with input current limit capability (e.g., a 500 mA current limit), and a microcontroller with two USB Peripheral PHYs. Each of the host USB ports are connected, via a USB cable, to one of the USB Peripheral PHYs and to one of the battery chargers of the cradle.

As shown in FIG. 1, the cradle includes a power storage unit (e.g., a battery or capacitor) that is charged by both battery chargers simultaneously. For example, the battery or capacitor may be charged to at least the minimum operational level for charging the barcode reader. In some examples, the battery or capacitor may store charge when the barcode reader is not present, for faster recharging when the barcode reader returns. Moreover, in some examples, the battery or capacitor may act as a buffer to prevent overloading a host USB port if the other host USB port is removed or otherwise disconnected.

The cradle further includes an inductive or high frequency resonant wireless power transmitter configured to draw 4.5 W max (0.5 W for cradle overhead) from the battery or capacitor, and wirelessly transmit the power to a barcode reader. The barcode reader in turn includes an inductive or high frequency resonant wireless power receiver configured to receive power transmitted by the wireless power transmitter of the cradle. The wireless power receiver of the barcode reader may provide power to a rechargeable battery of the barcode reader.

Additionally, the cradle shown in FIG. 1 further includes a power mux that draws power from the battery chargers to power the microcontroller from either of the host USB ports. The microcontroller enumerates each USB Peripheral PHY as a separate device to the host computing device. Moreover, in some embodiments, the microcontroller enables the wireless power transmitter only after enumerating on both host ports. Furthermore, in some embodiments, if one of the host USB ports is disconnected, the microcontroller disables the wireless power transmitter gracefully, and the battery/capacitor absorbs any power transients to avoid overload on remaining USB port.

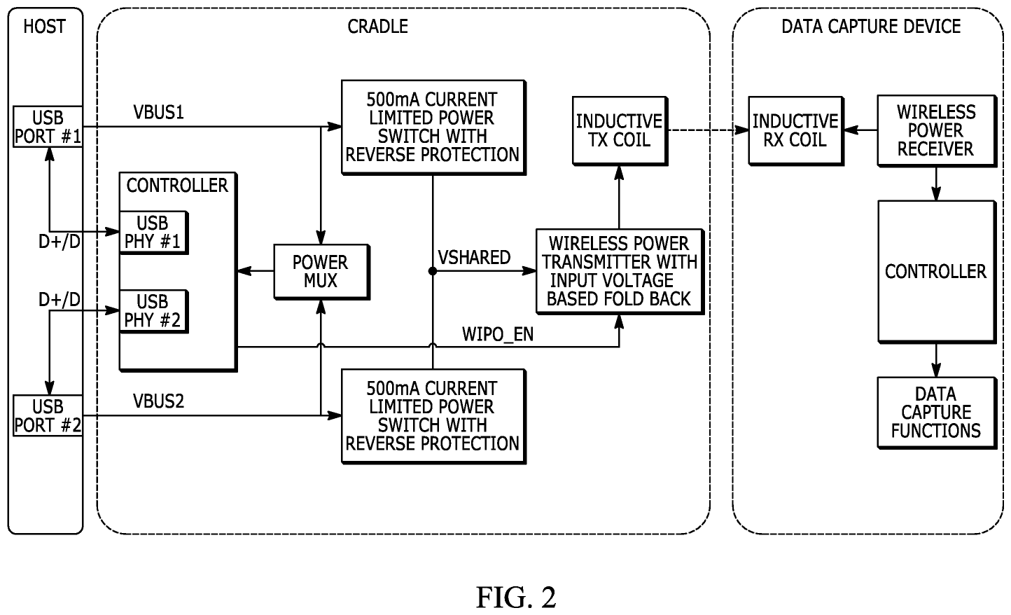

In FIG. 2, a block diagram of an exemplary dual USB-powered cradle, without an internal power storage unit, for wirelessly charging a barcode reader, is illustrated in accordance with an embodiment of the present application. Generally speaking, the exemplary dual USB-powered cradle illustrated in FIG. 2 operates similarly to the exemplary dual USB-powered cradle illustrated in FIG. 1. However, exemplary dual USB-powered cradle illustrated in FIG. 2 does not include a battery, capacitor, or other internal power storage unit or corresponding battery chargers. Instead, the battery chargers illustrated in the exemplary dual USB-powered cradle of FIG. 1 are replaced with current limiters (e.g., current limited switches with reverse protection or other simple current sources) that power the wireless power transmitter directly. Moreover, the wireless power transmitter of the exemplary dual USB-powered cradle illustrated in FIG. 2 includes input voltage based feedback.

Accordingly, when the current limiters reach their current limit, their output voltage begins to fall, and, in turn, the wireless power transmitter's power is throttled down in response to low input voltage. Consequently, the system reaches equilibrium at an input voltage setpoint as measured at the input to the wireless power transmitter. Generally speaking, the equilibrium setpoint may be set to a power level above what a single host USB port could support alone (i.e., due to the fact that the power of two host USB ports is combined).

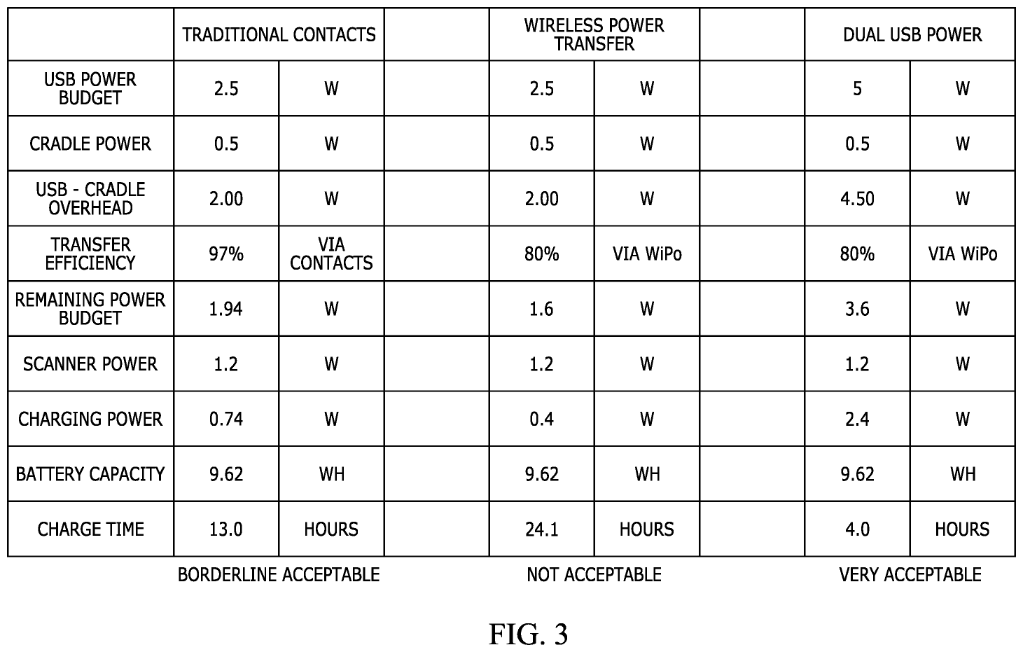

In FIG. 3, a chart comparing charge times for an example barcode reader (Zebra DS8178) using traditional contact charging by a cradle powered by a single USB port, wireless charging by a cradle powered by a single USB port, and wireless charging by a cradle powered by a combination of two USB ports, in accordance with embodiments of the present application, is illustrated. As shown in the chart of FIG. 3, the Zebra DS8178 has a charge time of 13.0 hours using traditional contact charging by a cradle powered by a single USB port, and a charge time of 24.0 hours using wireless charging by a cradle powered by a single USB port. However, the Zebra DS8178 has a charge time of 4.0 hours using wireless charging by a cradle powered by a combination of two USB ports in accordance with embodiments of the present application. Advantageously, wireless charging by a cradle powered by a combination of two USB ports results in a much quicker charge time compared to the more traditional methods of traditional contact charging by a cradle powered by a single USB port or wireless charging by a cradle powered by a single USB port.

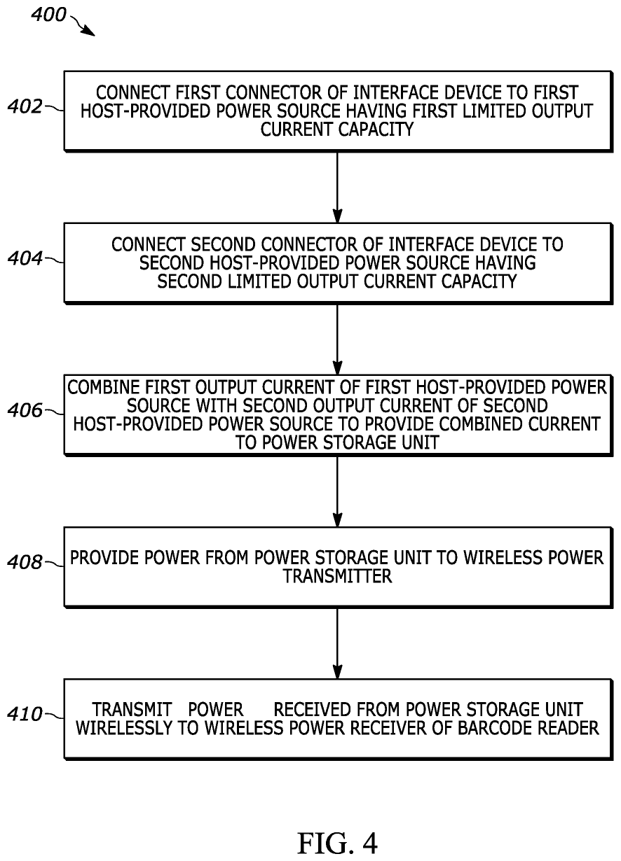

In FIG. 4, an exemplary flow diagram of a method for using multiple power sources with limited output capacity to power an interface device for wirelessly charging a barcode reader is illustrated, in accordance with an embodiment of the present application.

A first connector of an interface device may be connected (block 402) to a first host-provided power source having a first limited output current capacity. In particular, the interface device may be configured to interface with a wireless power receiver of a barcode reader that provides power to a rechargeable battery of the barcode reader. For example, the interface device may be a cradle configured to receive at least one of a wireless power receiver and a barcode reader having the wireless power receiver installed therein.

A second connector of the interface device may be connected (block 404) to a second host-provided power source having a second limited output current capacity. In particular, the first connector may be enumerated to the host computing device as a first device, while the second connector may be enumerated to a host computing device as a second device that is distinct from the first device. In some examples, the first host-provided power source may be a first Universal Serial Bus (USB) port with an output current capacity of 500 mA, and/or the second host-provided power source may be a second USB port with an output current capacity of 500 mA. For instance, the combined output current capacity of the first host-provided power source and the second host-provided power source may be less than or equal to 1 A.

The first output current of the first host-provided power source may be combined (block 406) with a second output current of the second host-provided power source to provide a combined current to a power storage unit. In some examples, the power storage unit is provided with combined current from the first host-provided power source and the second host-provided power source simultaneously.

Power from the power storage unit may be provided (block 408) to a wireless power transmitter. In some examples, the wireless power transmitter may require at least 4.5 W of power for operation. Power received from the power storage unit may be transmitted (block 410) wirelessly to the wireless power receiver of the barcode reader. The wireless power receiver of the barcode reader may provide power to a rechargeable battery of the barcode reader.

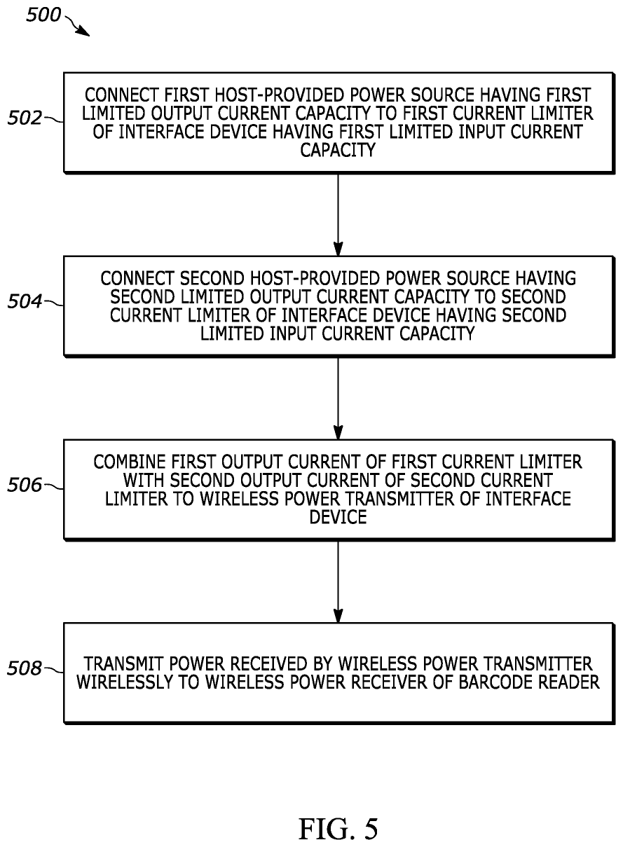

In FIG. 5, an exemplary flow diagram of another method for using multiple power sources with limited output capacity to power an interface device for wirelessly charging a barcode reader is illustrated, in accordance with an embodiment of the present application.

A first host-provided power source having a first limited output current capacity may be connected (block 502) to a first current limiter of an interface device configured to interface with a wireless power receiver of a barcode reader, e.g., by a first connector of the interface device. For example, the interface device may be a cradle configured to receive at least one of a wireless power receiver and a barcode reader having the wireless power receiver installed therein. A second host-provided power source having a second limited output current capacity may be connected (block 504) to a second current limiter of the interface device, e.g., by a second connector of the interface device. In particular, the first connector may be enumerated to the host computing device as a first device, while the second connector may be enumerated to a host computing device as a second device that is distinct from the first device.

The first current limiter may have a first limited input current capacity, while the second current limiter may have a second limited input current capacity. Moreover, the first and second current limiters may be first and second current-limited switches in some examples. In other examples, the first and second currently limiters may be purpose-built current sources. Furthermore, in some examples, the first host-provided power source may be a first Universal Serial Bus (USB) port with an output current capacity of 500 mA, and/or the second host-provided power source may be a second USB port with an output current capacity of 500 mA. In some examples, the combined output current capacity of the first host-provided power source and the second host-provided power source may be less than or equal to 1 A.

The first output current of the first current limiter may be combined (block 506) with the second output current of the second current limiter to provide a combined current to a wireless power transmitter of the interface device. For instance, the wireless power transmitter of the interface device may be provided with combined current from the first host-provided power source and the second host-provided power source simultaneously. In some examples, the wireless power transmitter may require at least 4.5 W of power for operation.

The power received by the wireless power transmitter may be transmitted (block 508) wirelessly to the wireless power receiver of the barcode reader. The wireless power receiver of the barcode reader may provide power to a rechargeable battery of the barcode reader.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system, comprising:
a host computing device having:
a first host-provided power source having a first limited output current capacity; and
a second host-provided power source having a second limited output current capacity; and
an interface device configured to interface with a wireless power receiver of a barcode reader that provides power to a rechargeable battery of the barcode reader, the interface device having:
a first connector connected to the first host-provided power source;
a second connector connected to the second host-provided power source;
a power storage unit configured to receive combined current from the first host-provided power source and the second host-provided power source; and
a wireless power transmitter configured to receive power from the power storage unit and transmit the power received from the power storage unit wirelessly to the wireless power receiver of the barcode reader.

2. The system of claim 1, wherein the first host-provided power source is a first Universal Serial Bus port, and wherein the second host-provided power source is a second Universal Serial Bus port.

3. The system of claim 1, wherein the combined output current capacity of the first host-provided power source and the second host-provided power source is less than or equal to 1 A.

4. The system of claim 1, wherein the power storage unit is configured to receive combined power from the first host-provided power source and the second host-provided power source simultaneously.

5. The system of claim 1, wherein the interface device is configured to enumerate, to the host computing device, the first connector as a first device and to enumerate, to the host computing device, the second connector as a second device distinct from the first device.

6. The system of claim 1, wherein the wireless power transmitter requires at least 4.5 W of power for operation.

7. The system of claim 1, wherein the interface device is a cradle configured to receive at least one of the wireless power receiver and the barcode reader having the wireless power receiver installed therein.

8. An interface device for interfacing with a wireless power receiver of a barcode reader that provides power to a rechargeable battery of the barcode reader and for further interfacing with a host computing device having a first host-provided power source having a first limited output current capacity and a second host-provided power source having a second limited output current capacity, the interface device comprising:
a first connector connected to the first host-provided power source;
a second connector connected to the second host-provided power source;
a power storage unit configured to receive combined current from the first host-provided power source and the second host-provided power source; and
a wireless power transmitter configured to receive power from the power storage unit and transmit the power received from the power storage unit wirelessly to the wireless power receiver of the barcode reader.

9. The interface device of claim 8, wherein the first host-provided power source is a first Universal Serial Bus port, and wherein the second host-provided power source is a second Universal Serial Bus port.

10. The interface device of claim 8, wherein the combined output current capacity of the first host-provided power source and the second host-provided power source is less than or equal to 1 A.

11. The interface device of claim 8, wherein the power storage unit is configured to receive combined power from the first host-provided power source and the second host-provided power source simultaneously.

12. The interface device of claim 8, wherein the interface device is configured to enumerate, to the host computing device, the first connector as a first device and to enumerate, to the host computing device, the second connector as a second device distinct from the first device.

13. The interface device of claim 8, wherein the wireless power transmitter requires at least 4.5 W of power for operation.

14. A method of charging a rechargeable battery of a barcode reader, the method comprising:
connecting a first connector of an interface device to a first host-provided power source having a first limited output current capacity, the interface device being configured to interface with a wireless power receiver of a barcode reader that provides power to a rechargeable battery of the barcode reader;
connecting a second connector of the interface device to a second host-provided power source having a second limited output current capacity;
combining a first output current of the first host-provided power source with a second output current of the second host-provided power source to provide a combined current to a power storage unit;
providing power from the power storage unit to a wireless power transmitter; and
transmitting the power received from the power storage unit wirelessly to the wireless power receiver of the barcode reader.

15. The method of claim 14, wherein the first host-provided power source is a first Universal Serial Bus port, and wherein the second host-provided power source is a second Universal Serial Bus port.

16. The method of claim 14, wherein the combined output current capacity of the first host-provided power source and the second host-provided power source is less than or equal to 1 A.

17. The method of claim 14, wherein the power storage unit is provided with combined current from the first host-provided power source and the second host-provided power source simultaneously.

18. The method of claim 14, further comprising:
enumerating, to a host computing device, the first connector as a first device; and
enumerating, to the host computing device, the second connector as a second device distinct from the first device.

19. The method of claim 14, wherein the wireless power transmitter requires at least 4.5 W of power for operation.

20. The method of claim 14, wherein the interface device is a cradle configured to receive at least one of the wireless power receiver and the barcode reader having the wireless power receiver installed therein.

21. A system, comprising:
a host computing device having:
a first host-provided power source having a first limited output current capacity; and
a second host-provided power source having a second limited output current capacity; and
an interface device configured to interface with a wireless power receiver of a barcode reader that provides power to a rechargeable battery of the barcode reader, the interface device having:
a first connector connecting the first host-provided power source to a first current limiter having a first limited input current capacity;
a second connector connecting the second host-provided power source to a second current limiter having a second limited input current capacity; and
a wireless power transmitter configured to receive combined current from the first current limiter and the second current limiter and transmit combined power from the first current limiter and the second current limiter wirelessly to the wireless power receiver of the barcode reader.

22. The system of claim 21, wherein the first current limiter is a first current-limited switch, and wherein the second current limiter is a second current-limited switch.

23. The system of claim 21, wherein the first current limiter is a first current source, and wherein the second current limiter is a second current source.

24. The system of claim 21, wherein the first host-provided power source is a first Universal Serial Bus port, and wherein the second host-provided power source is a second Universal Serial Bus port.

25. The system of claim 21, wherein the combined output current capacity of the first host-provided power source and the second host-provided power source is less than or equal to 1 A.

26. The system of claim 21, wherein the wireless power transmitter is configured to receive combined power from the first current limiter and the second current limiter simultaneously.

27. The system of claim 21, wherein the interface device is configured to enumerate, to the host computing device, the first connector as a first device and to enumerate, to the host computing device, the second connector as a second device distinct from the first device.

28. The system of claim 21, wherein the wireless power transmitter requires at least 4.5 W of power for operation.

29. The system of claim 21, wherein the interface device is a cradle configured to receive at least one of the wireless power receiver and the barcode reader having the wireless power receiver installed therein.

30. An interface device for interfacing with a wireless power receiver of a barcode reader that provides power to a rechargeable battery of the barcode reader and for further interfacing with a host computing device having a first host-provided power source having a first limited output current capacity and a second host-provided power source having a second limited output current capacity, the interface device comprising:
a first connector connecting the first host-provided power source to a first current limiter having a first limited input current capacity;
a second connector connecting the second host-provided power source to a second current limiter having a second limited input current capacity; and
a wireless power transmitter configured to receive combined current from the first current limiter and the second current limiter and transmit combined power from the first current limiter and the second current limiter wirelessly to the wireless power receiver of the barcode reader.

31. The interface device of claim 30, wherein the first current limiter is a first current-limited switch, and wherein the second current limiter is a second current-limited switch.

32. The interface device of claim 30, wherein the first current limiter is a first current source, and wherein the second current limiter is a second current source.

33. The interface device of claim 30, wherein the first host-provided power source is a first Universal Serial Bus port, and wherein the second host-provided power source is a second Universal Serial Bus port.

34. The interface device of claim 30, wherein the combined output current capacity of the first host-provided power source and the second host-provided power source is less than or equal to 1 A.

35. The interface device of claim 30, wherein the wireless power transmitter is configured to receive combined power from the first current limiter and the second current limiter simultaneously.

36. The interface device of claim 30, wherein the interface device is configured to enumerate, to the host computing device, the first connector as a first device and to enumerate, to the host computing device, the second connector as a second device distinct from the first device.

37. The interface device of claim 30, wherein the wireless power transmitter requires at least 4.5 W of power for operation.

38. A method of charging a rechargeable battery of a barcode reader, comprising:
connecting, by a first connector of an interface device configured to interface with a wireless power receiver of a barcode reader, a first host-provided power source having a first limited output current capacity to a first current limiter of the interface device, the first current limiter having a first limited input current capacity;
connecting, by a second connector of the interface device, a second host-provided power source having a second limited output current capacity to a second current limiter of the interface device, the second current limiter having a second limited input current capacity;
combining a first output current of the first current limiter with a second output current of the second current limiter to provide a combined current to a wireless power transmitter of the interface device; and
transmitting the power received by the wireless power transmitter wirelessly to the wireless power receiver of the barcode reader, wherein the wireless power receiver of the barcode reader is configured to provide power to a rechargeable battery of the barcode reader.

39. The method of claim 38, wherein the first current limiter is a first current-limited switch, and wherein the second current limiter is a second current-limited switch.

40. The method of claim 38, wherein the first current limiter is a first current source, and wherein the second current limiter is a second current source.

41. The method of claim 38, wherein the first host-provided power source is a first Universal Serial Bus port, and wherein the second host-provided power source is a second Universal Serial Bus port.

42. The method of claim 38, wherein the combined output capacity of the first host-provided power source and the second host-provided power source is less than or equal to 1 A.

43. The method of claim 38, wherein the wireless power transmitter is provided with combined current from the first current limiter and the second current limiter simultaneously.

44. The method of claim 38, further comprising:
enumerating, to a host computing device, the first connector as a first device; and
enumerating, to the host computing device, the second connector as a second device distinct from the first device.

45. The method of claim 38, wherein the wireless power transmitter requires at least 4.5 W of power for operation.

46. The method of claim 38, wherein the interface device is a cradle configured to receive at least one of the wireless power receiver and the barcode reader having the wireless power receiver installed therein.
